(19) United States
(12) Patent Application Publication
(10) Pub. No.: US 2013/0328691 A1
(43) Pub. Date: Dec. 12, 2013

(54) METHOD AND SYSTEM FOR COMMUNICATION FOR UNDERWATER COMMUNICATIONS

(71) Applicant: James Hugh Coble, Chester, NJ (US)

(72) Inventor: James Hugh Coble, Chester, NJ (US)

(73) Assignee: TYCO ELECTRONICS SUBSEA COMMUNICATIONS LLC, Morristown, NJ (US)

(21) Appl. No.: 13/494,927

(22) Filed: Jun. 12, 2012

(51) Int. Cl. H04B 13/02

(52) U.S. Cl. 340/850

(57) ABSTRACT

An apparatus for underwater communications. The apparatus may include a high speed communications cable to provide an underwater hardwired communications link to a surface station and a mobile device operative to transport a first end of the high speed communications cable between a submarine and a coupling point to the surface communication station, wherein the high speed communications cable is operative to reversibly form a hardwired connection between the coupling point and the submarine.

### BACKGROUND OF THE INVENTION

1. Field of the Invention

Embodiments of the invention relate to the field of communications.

2. Discussion of Related Art

In current technology, communication between a submerged submarine and a location external to the submarine, such as a surface vessel, is difficult. In particular, radio frequency electromagnetic radiation is poorly conducted through an electrically conductive medium such as salt water. This has led to the practice of surfacing a submarine to conduct radio communications as necessary, with the disadvantage that the surfaced submarine is more easily detectable when located on the surface of a body of water. Another approach is to employ sonic communications because of the relatively long travel distance of sound in water. For example, a sonic communication station may be placed at various locations underwater. A submarine located near a sonic communication station may communicate by sound waves with the sonic communication station, which, in turn, may communicate via cable with a surface vehicle.

Other approaches for communicating with underwater submarines involve the use of electromagnetic frequencies at ranges lower than normal radio frequencies, which are variously termed ultralow frequency (ULF), very low frequency (VLF), or extremely low frequency. At these lower frequency ranges, communications rates at best approach the low Mbit/sec rate and require specially transmission facilities. For example, VLF communications using electromagnetic radiation in the range of 3 to 30 kHZ is limited to a distance of about 20meters below the surface of the water. In addition, because of a low bandwidth, VLF radio signals cannot easily carry voice or other high-bandwidth information.

In a further approach, extremely low frequency (ELF) electromagnetic communications may be conducted at about three to three hundred Hz, at which frequency range communications with submarines may take place to depths of several hundred meters, allowing submarines to communicate in principle with surface entities while submerged at a normal operating depth. However, due to the long wavelength associated with ELF, a transmitter in an ELF communications system would require transmitter ends to be located tens or hundreds of kilometers apart, rendering ELF-based systems difficult to implement.

In all of the above approaches, the bandwidth for communicating information is relatively low as compared to that afforded by present day RF or optical communications, for example.

In view of the above it will be apparent that a need exists to improve communications between a submerged submarine and above-surface entity.

### SUMMARY OF THE INVENTION

Embodiments of the present disclosure are directed to systems and methods for communications with an underwater vehicle such as a submarine.

In one embodiment an apparatus for underwater communications may include a high speed communications cable to provide an underwater hardwired communications link to a surface station; a mobile device operative to transport a first end of the high speed communications cable between a submarine and a coupling point to the surface communication station, wherein the high speed communications cable is operative to reversibly form a hardwired connection between the coupling point and the submarine.

In another embodiment, a method for high speed underwater communications may include connecting a first end of a high speed communications cable to a mobile device, transporting the mobile device underwater from a launching point to a coupling point, forming a wet mate connection between the mobile device and coupling point, wherein the high speed communications cable is extended between an underwater submarine and a hardwired link to a surface communications station so as to form a high speed communications link between the underwater submarine and surface communications station.

### BRIEF DESCRIPTION OF THE DRAWINGS

FIG. 1 is a schematic depiction of an exemplary apparatus.

FIG. 2 depicts an exemplary system.

FIG. 3a depicts a first stage of an exemplary scenario for deploying an apparatus according to the present embodiments.

FIG. 3b depicts a second stage of the exemplary scenario of FIG. 3a.

FIG. 3c depicts a third stage of the exemplary scenario of FIG. 3a.

FIG. 3d depicts a fourth stage of the exemplary scenario of FIG. 3a.

FIG. 3e depicts a fifth stage of the exemplary scenario of FIG. 3a.

FIG. 4a depicts a first stage of another exemplary scenario for deploying an apparatus according to the present embodiments.

FIG. 4b depicts a second stage of the exemplary scenario of FIG. 4a.

FIG. 4c depicts a further exemplary scenario for deploying an apparatus according to the present embodiments.

FIG. 5 depicts details of an exemplary cable.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

To solve the deficiencies associated with the methods noted above, novel and inventive techniques for managing communications, and in particular, communications between an undersea vehicle, such as a submarine, and surface communications stations that may be located on a surface vessel, such as a ship or located elsewhere above water or on land. In the present embodiments, at least a portion of the communications path between the submarine and surface communication station takes place underwater. The present embodiments address deficiencies in known techniques for communicating with an underwater vessel such as a submarine by providing a hardwire communications link that can be connected and disconnected between the submarine and a surface communication station as desired.

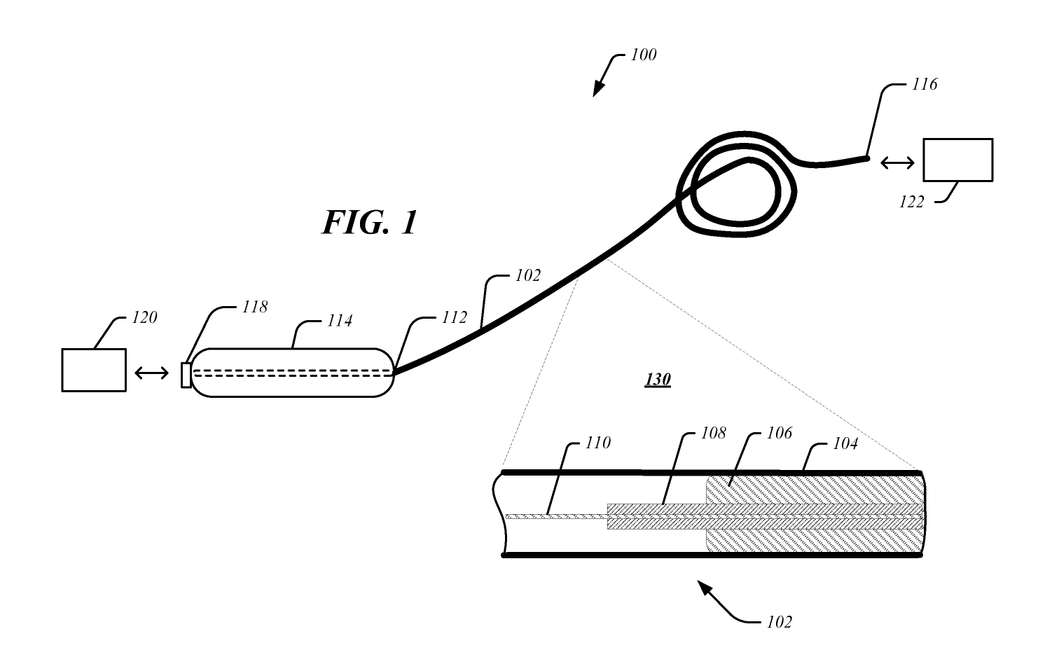

Referring to the drawings, FIG. 1 depicts an exemplary apparatus 100. In this embodiment, the apparatus 100 includes a high speed communication cable 102. As described below with respect to the FIGS. to follow, the apparatus 100 and variants thereof may be deployed to facilitate high speed communications between surface stations and an underwater station that is located in a vehicle such as a submarine when the vehicle is submerged in a body of water. The terms “surface station” or “surface communication station” as used herein, refer to any communication apparatus that is not located undersea. The surface station may be located in a vessel on the surface of a body of water or may be based upon land. Examples of a surface station as well as underwater station include equipment that provides the function of a private branch exchange (PBX), a submarine line termination equipment (SLTE), or other equipment operable to terminate and/or receive signals.

In various embodiments, the apparatus 100 provides the ability to conveniently establish and sever a high speed communication link between a submerged vehicle and a surface communications station, as desired. In particular, as shown in FIG. 1, the high speed communication cable 102 may include an optical fiber(s) 108 as illustrated in the expanded view 130. The high speed communication cable 102 may include various other components such as a metal cylinder 108, support structure 106, which may include metal cables, and outer insulator layer(s) 104. These features facilitate the underwater use of the high speed communication cable 102 to link the submerged vehicle with surface stations so that high speed communications may take place even when the vehicle is submerged tens or hundreds of meters below the water surface.

As also depicted in FIG. 1, the high speed communication cable 102 may couple at a first location 112 to a mobile device 114, which may be a self-propelled vehicle. The first location 112 may, but need not be, a first end of the high speed communication cable 102. In particular embodiments, the mobile device 114 may be an autonomous underwater vehicle (AUV) that can be launched from a host, such as a surface ship or a submarine. In various embodiments, the mobile device 114 includes a connector 118 that may reversibly connect to a coupling point (not shown) to link to a first communications station 120. In some embodiments, the high speed communication cable 102 may extend within the mobile device to the connector 118. As further illustrated in FIG. 1, a second location 116 of the high speed communications cable 102 generally located on an opposite end to the location 112, may couple to a second communications station 122. In various embodiments, the second communications station is located in the host that launches the mobile device 114, as detailed below. When the apparatus 100 is connected on both ends to form a hardwire connection between the respective first and second communications stations 120, 122, high speed communications may take place therebetween.

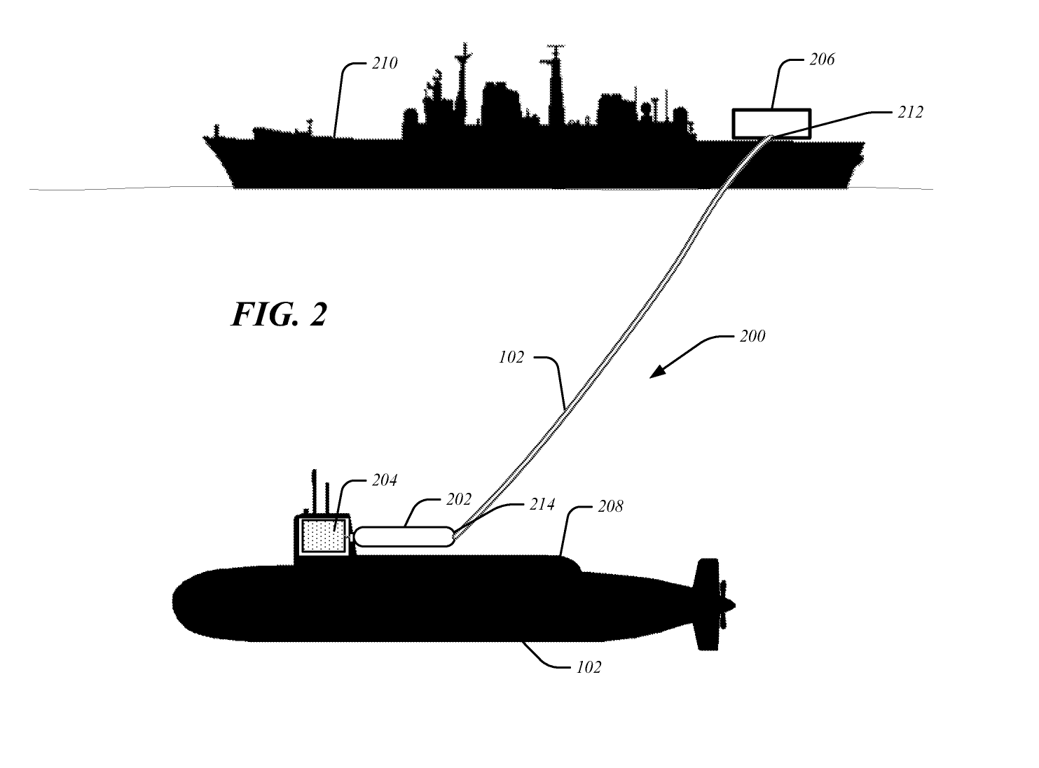

FIG. 2 depicts an exemplary system 200 that facilitates high speed underwater communications between a submarine and surface vessel. The system 200 includes a high speed communications cable 102 and a mobile device 202, which together provide a high speed communication link between the communications stations 204 and 206 in the scenario of FIG. 2. As illustrated, the communication station 204 is located in a conning tower of the submarine 208 and the communication station 206 is located on the surface ship 210. Although depicted as residing on the ship's deck, the communication station 206 may be located within the hull of the surface ship 210 or any convenient location. As noted previously, the communications stations 204, 206 may provide PBX or SLTE functionality. Moreover, high speed communications may take place between the submarine 208 and other locations above the water surface that are communicatively linked to the surface ship 210, for example, via known radio communication techniques.

As further shown in FIG. 2, the submarine 208 may remain submerged well below the surface of the water and may position itself, for example, within a shadow cast by the surface ship 210 while connected through the system 200. In this manner, the submarine may remain at least partially obscured from overhead view or other sensing techniques while located proximate the surface ship 210. The system 200 thus provides the advantage that the submarine 208 and surface ship 210 can exchange communications at high bandwidth and high speed without the submarine having to surface so that the submarine may remain much less easily detectable than if surfacing were required in order to conduct high speed communication. Moreover, the system 200 provides a reversible link between submarine 208 and surface ship 210 so that the submarine need only be physically tethered to the surface ship when high speed communications are to take place and is otherwise operable independent of the surface ship 210.

In the example illustrated, the mobile device 202 may be an AUV that is launched from the surface ship 210 and connects to a wet mate connector (not explicitly shown) provided on the submarine 208 to establish a high speed communications link. A wet mate connector may provide a mechanical plug-in match between the mobile device 202 and submarine 208, so that communications lines within the submarine, such as fiber optic lines, are aligned to respective communications lines in the high speed communications cable 102. It is to be noted that the mobile device 201 and surface ship 210 as well as submarine 208 are not necessarily presented to scale. In some embodiments, the mobile device 202 may be a self-propelled underwater unmanned vehicle having a length of about five feet to about thirty feet and having a diameter of about one foot to about five feet. The embodiments are not limited in this context. The mobile device 202 may have a hull of sufficient strength to withstand water pressure at least to an operation depth for the mobile device 202, which may be up to one thousand meters in some embodiments.

A first end 212 of the high speed communications cable 102 may be connected to equipment within the surface ship 210, so that a high speed communications link is established to the communications station 206. The high speed communications cable 102 and mobile device 202 may be interoperable so that the length of the high speed communications cable 102 that extends from surface ship 210 increases as the mobile device 202 moves away from the surface ship 210. For example, the high speed communications cable 102 may be feed from a spool or other device located inside or outside the hull of the surface ship 210. Although not explicitly shown, a communications path, such as additional high speed communication cable or an additional portion of the high speed communication cable 102 may extend through the mobile device 202 from the point 214 at which the high speed communications cable 102 meets the mobile device 202. Thus, when the mobile device 202 connects to the submarine 208, a high speed communications link may be completed between the communications stations 204 and 206.

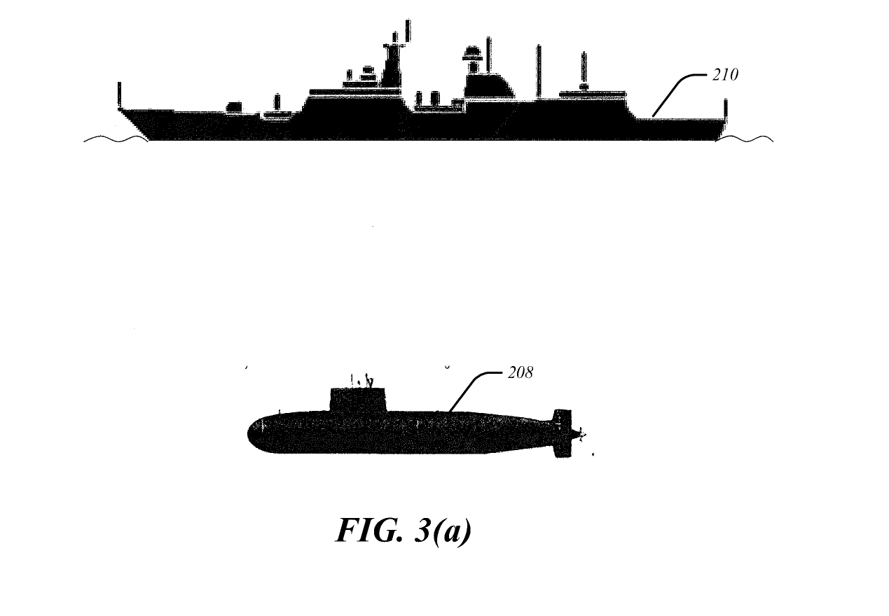

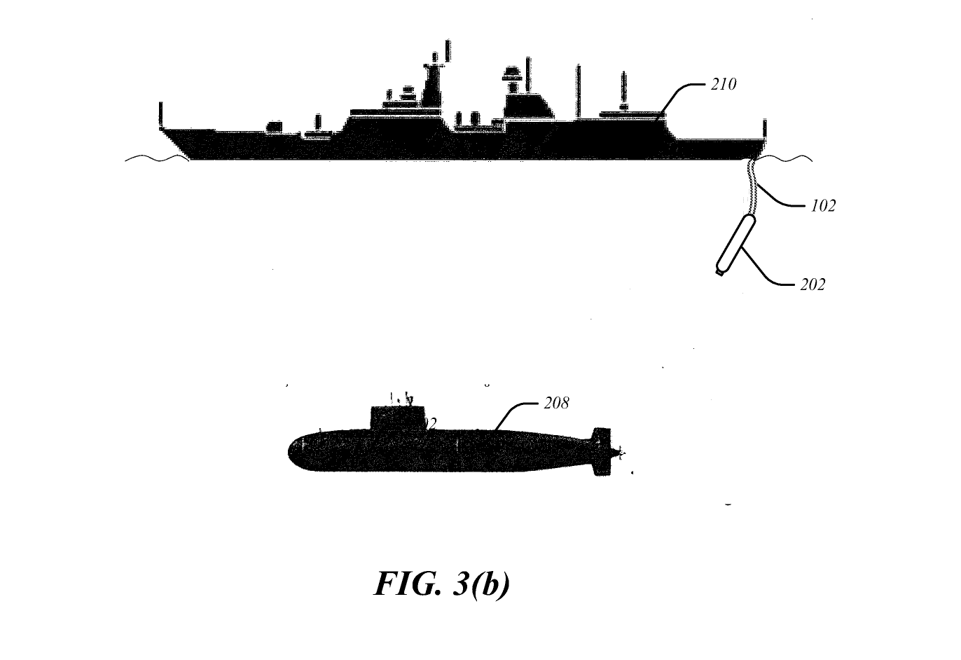

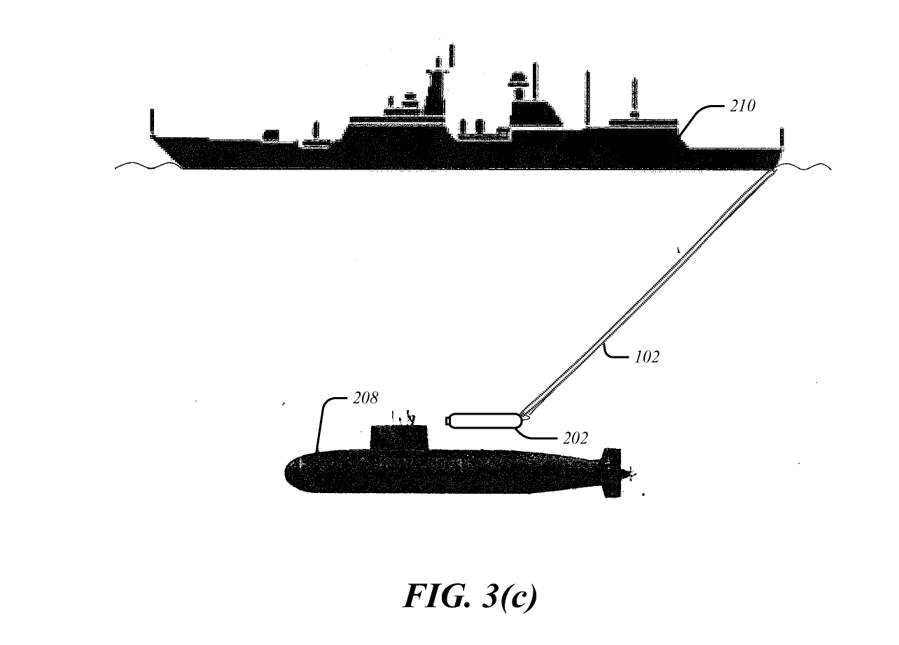

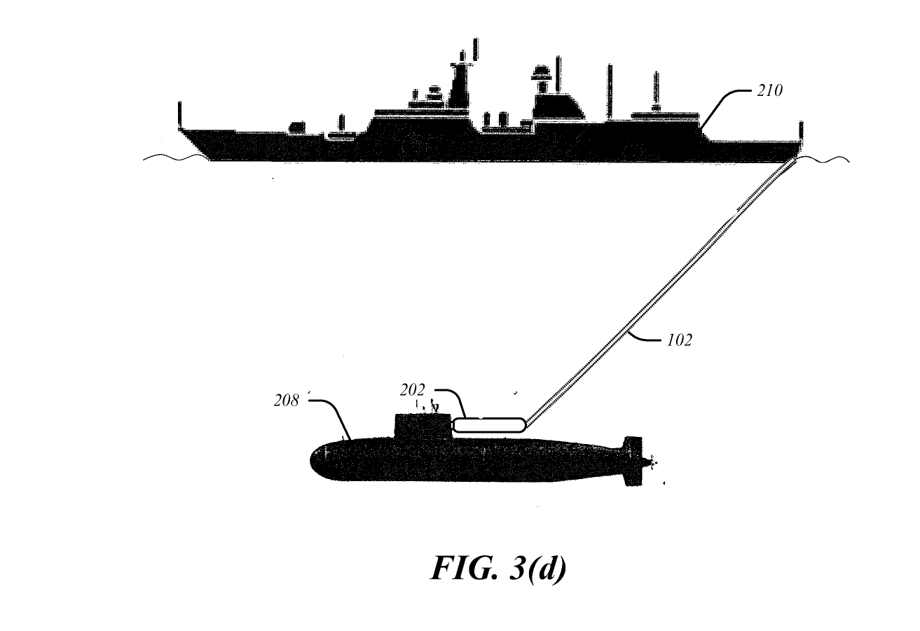

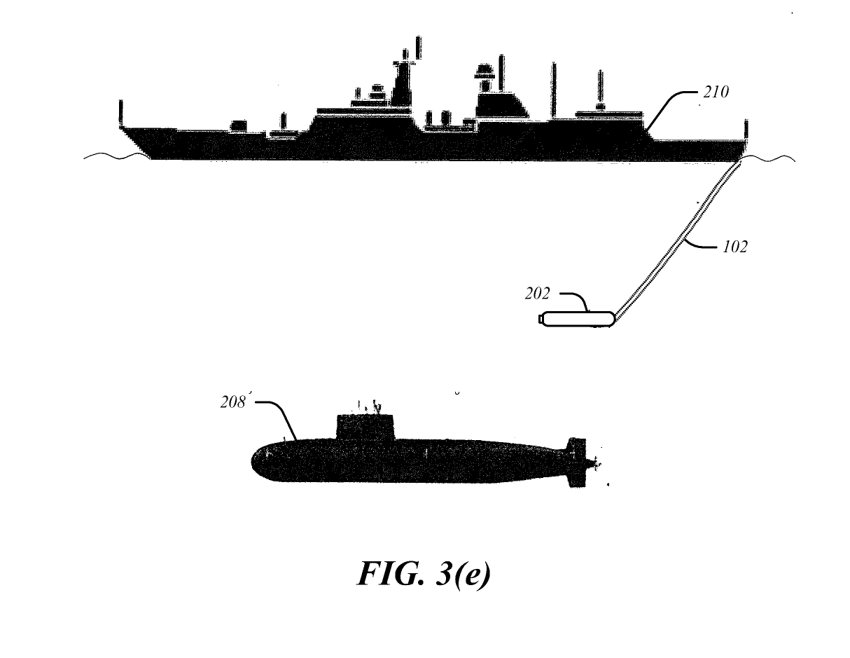

FIGS. 3(a) to 3(e) depict different stages in a communications session that may be established between a submarine and surface vessel consistent with the present embodiments. When it is desirable for high speed high bandwidth communications to be established between the submarine 208 and the “outside world” the submarine 208 and surface ship 210 may draw into proximity of one another. For example, in one implementation the system 200 described above with respect to FIG. 2 may provide the ability to establish a hardwire connection up to 1000 meters from the surface ship 210. In other words, the mobile device and high speed communication cable may extend up to 1000 meters from the surface ship 210. Accordingly, the surface ship 210 and submarine 208 may be brought to within one thousand meters of one another in order to establish a hardwire link between the two, as generally suggested by FIG. 3a.

Subsequently, the mobile device 202 may be dispatched from the surface ship 210. In one example, the mobile device 202 may be housed within the hull of the surface ship 210; however, in other examples, the mobile device 202 may be housed on the outside of the hull of the surface ship 210. In accordance with some embodiments, telemetry may be provided to guide the mobile device 202 to dock with the submarine 208. Accordingly, once launched, the mobile device 203 may proceed towards submarine 208. FIG. 3b shows an instance in which the mobile device 202 has been launched from the surface ship 210 but is still in close proximity to the surface ship 210. At this instance, the length of high speed communications cable 102 that extends from the hull of the surface ship 210 may be relatively shorter. Subsequently, as depicted in FIG. 3(c), the mobile device 202 may approach the submarine 208, at which point the length of the high speed communications cable 102 that extends from the hull of the surface ship 210 is relatively longer.

At a later instance in time the mobile device 202 may be guided to dock with a connection point in the submarine 208, as illustrated at FIG. 3(d). Although not explicitly illustrated, the submarine 208 and/or mobile device 202 may include a wet mate type connector, which may be located at the nose of the mobile device 202, in order to link the submarine 208 and mobile device 202. In some embodiments, the mobile device 202 may contain one or more cameras (not shown) to aid in steering the mobile device 202 for linking with the submarine 208. In one example, the camera(s) may be linked via a fiber optic connection provided in the high speed communications cable 102 to a remote display viewable by an operator so that the mobile device may be properly guided for docking. Once the mobile device 202 is docked at the submarine 208, a high speed communication session may be initiated.

Although the high speed communications cable 102 is depicted as taut in the FIG. 3(d), in some examples, the submarine 208 may be tethered to the surface ship 210 in such a manner that slack is provided in the high speed communications cable 102. However, consistent with some embodiments, the high speed communications cable 102 may have sufficient mechanical strength to tether the submarine 208 to the surface ship 210 even when taut.

Subsequently, the high speed communications session between the submarine 208 and surface ship 210 may be completed and it may be desirable for the submarine 208 to leave the vicinity of the surface ship 210. FIG. 3(e) depicts a later instance in which the mobile device 202 has disconnected from the submarine 208 and is being retracted towards the surface ship 210. As the mobile device 202 moves toward the surface ship 210, the high speed communications cable 102 may be retracted. In one example, the high speed communications cable 102 may be retracted on a spool or other device. At the instance depicted in FIG. 3e, or any time thereafter, the submarine 208 may begin to depart from the vicinity of the surface ship 210, or the surface ship 210 may depart the vicinity. In particular, the submarine 208 may submerge to a deeper depth below the water's surface, thereby completing a high speed communications session with the surface ship while remaining undetected by other parties.

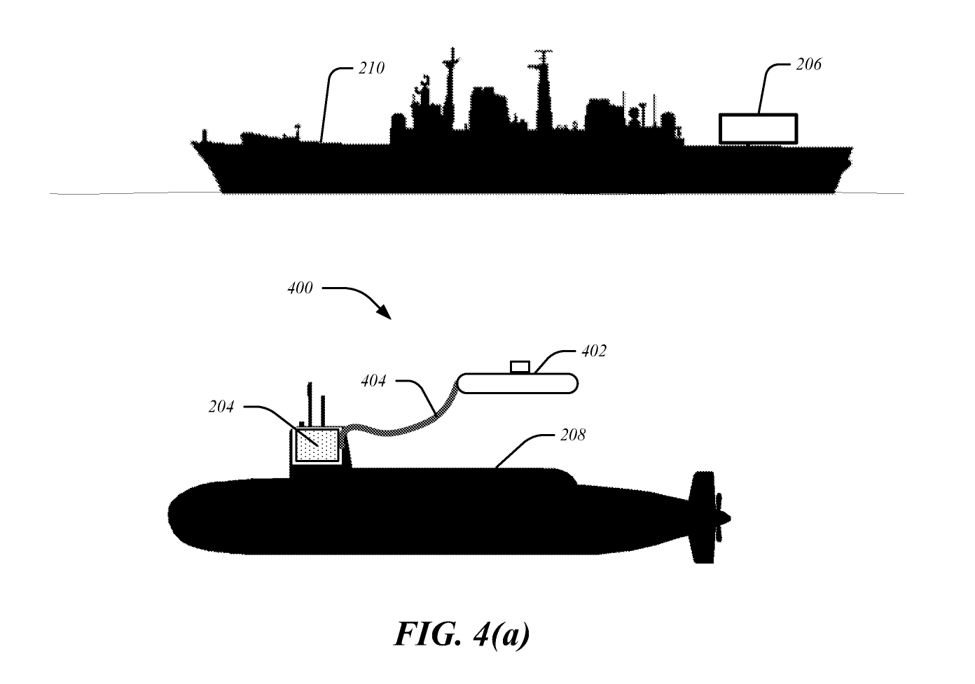

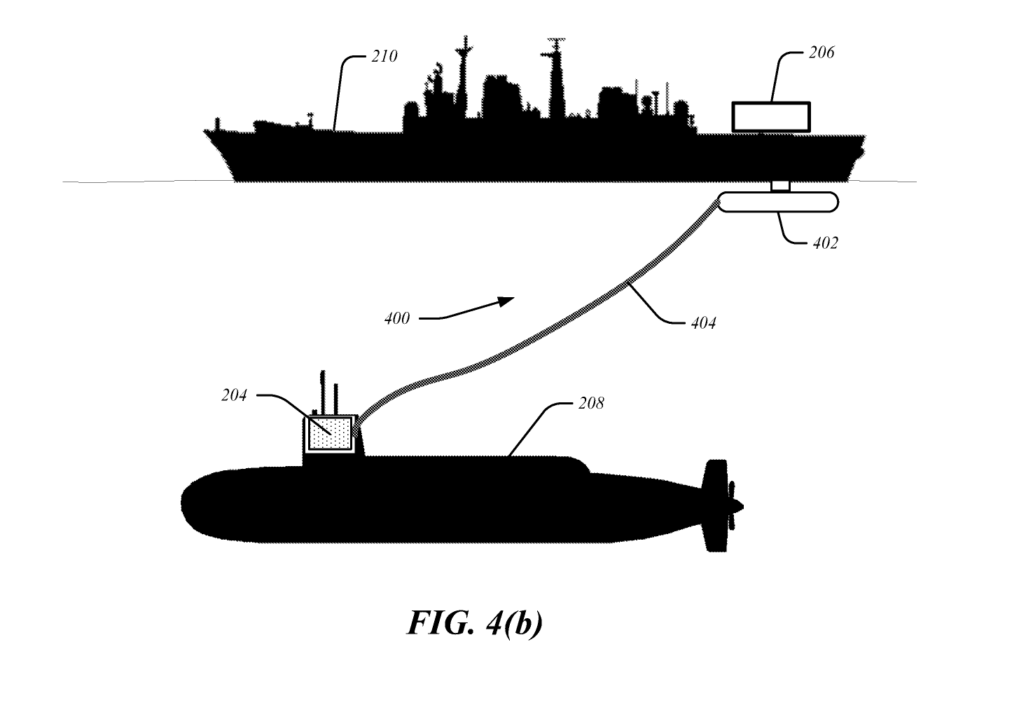

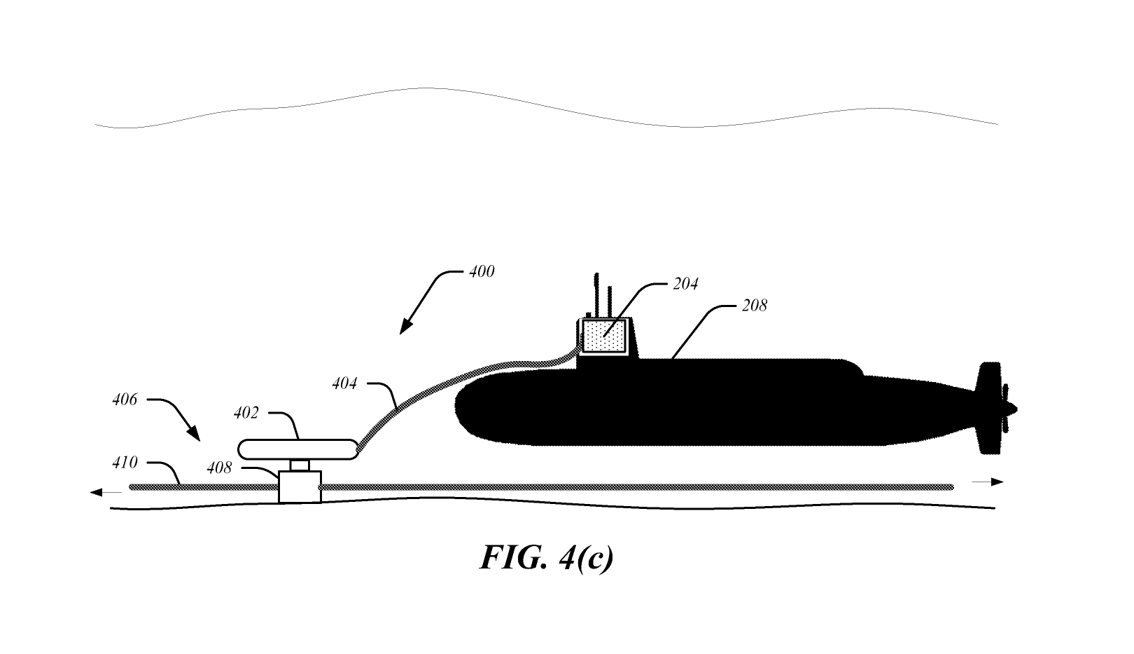

In further embodiments, instead of launching a mobile device from a surface vessel to provide a hardwire connection between submarine and the surface vessel, the submarine itself may serve as a launching point for a mobile device. FIGS. 4(a) and 4(b) depict a scenario in which an apparatus 400 includes a mobile device 402 that is launched from a submarine 208 to dock with the surface ship 410. In FIG. 4a, the mobile device 402 is launched from the submarine 208 and trails a high speed communications cable 404 behind. The mobile device 402 may be guided to the ship 410 and subsequently dock with the ship, for example, at a point on the hull of the ship 410, as illustrated in FIG. 4(b). Subsequently, the mobile device 402 may return to the submarine 208.

An advantage of launching a mobile device from a submarine in order to couple the submarine to surface stations is that the mobile device may be coupled to other vehicles or structures besides a surface ship. For example, a mobile device may be launched from a submarine to connect to a node of a subsea communications network, which may be a high speed communications network. FIG. 4(c) depicts one such scenario in which a mobile device 402 is launched from the submarine 208 to link to a subsea network 406. As illustrated in FIG. 4(c), the mobile device 402 may connect to a node 408 that is located on a seabed. The node 408 is connected to a subsea cable 410, which may be part of a high speed communications path, such as a fiber optic network. In various embodiments, the subsea network 406 may be a private network that is linked to surface stations, such as stations located on land, thereby providing high speed communications between a land-based user and the submarine 208. In one embodiment, a series of nodes of a private subsea network may be located at positions known to the submarine so that the submarine may link to the subsea network using mobile device 402 at various different locations as desired.

In order to facilitate reversible process of coupling and decoupling a hardwired link between a submarine and surface communication station, in some embodiments, the high speed communications cable that is employed to couple to the submarine may be modified from the structure of conventional high speed communications cables. For example, because different portions of the high speed communications cable may be deployed at different distances from a surface vessel when the high speed communications cable is connected between a submarine and the surface vessel, the different portions of the high speed communications cable may typically be deployed at different depths with respect to the water surface. Because the water pressure increases with depth, the mechanical forces experienced by such a cable may thereby vary as a function of position on the cable, such that those cable portions to be deployed furthest from the surface vessel experience greater forces.

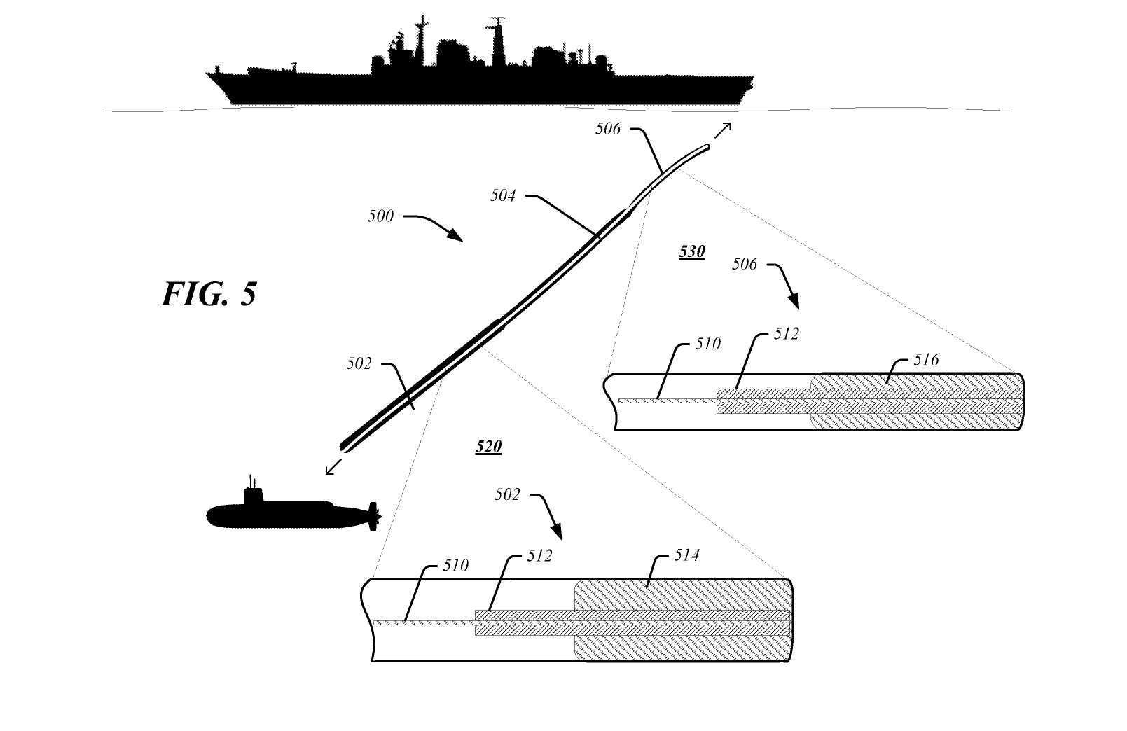

Consistent with various embodiments, FIG. 5 depicts a high speed communications cable 500 that may be employed to link a submarine with a surface vessel. The high speed communications cable 500 includes a portion 502, a portion 504, and a portion 506. As illustrated in the expanded views 520 and 530, the high speed communications cable 550 may include an inner fiber optic portion 510 that is surrounded by a metal tube 520. The outer region of the high speed communication cable 520 may include material to supply mechanical strength to the cable. As shown in FIG. 5, the diameter of the outer region of the high speed communications cable, which surrounds the metal tube 520, may vary among the different portions 502, 504, 506. For example, as illustrated in FIG. 5, the diameter of outer region 514 of portion 502 may be greater than the diameter of outer region 516 of portion 506. This may impart an increased strength to the portion 502 as opposed to that of portion 506. The strength of portion 504, which may have an intermediate diameter, may lie between that of portion 502 and portion 506. Although the outer diameter of the high speed communications cable 500 is depicted as varying among the different portions 502, 504, 506, in some embodiments, the outer diameter of the high speed communications cable may be constant, but the strength of the different portions may still vary.

By providing a variable strength at different portions of its length, the high speed communications cable 500 may provide better overall performance as opposed to a cable of uniform mechanical properties along its length. For example, a stronger portion, such as portion 502 may be designed to operate at locations that are the most distant from a surface vessel and therefore may be at greater depths below the water surface. At these greater depths, the greater mechanical strength may increase the durability and therefore lifetime of the high speed communications cable. On the other hand, a less strong portion, such as portion 502, may be designed to operate closer to the surface vessel where water pressure is less and therefore cable strength requirements are less. The less stringent strength requirement for portion 502 may allow a given length of the portion 502 to be lighter than the same length of portion 506, thereby reducing the overall weight of the high speed communications cable 500.

Herein, novel and inventive apparatus and techniques for providing high speed high throughput communications between an underwater submarine and a surface station are disclosed. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An apparatus for underwater communications, comprising:
a communications cable to provide an underwater hardwired communications link to a surface communication station; and
a mobile device operative to transport a first end of the communications cable between a submarine and a coupling point to the surface station, wherein the communications cable is operative to reversibly form a hardwired connection between the coupling point and the submarine.

2. The apparatus of claim 1, the communications cable operable to provide telemetry to guide the mobile device between the submarine and the coupling point.

3. The apparatus of claim 1, the hardwired communications link comprising an optical communications link operative to link a first set of communication equipment located in the submarine with the surface communication station.

4. The apparatus of claim 1, comprising a wet mate connector operable to form an underwater hardwire connection between the submarine and a coupling point to the surface communication station.

5. The apparatus of claim 1, the mobile device comprising an autonomous underwater vehicle that is self propelled.

6. The apparatus of claim 1, the mobile device configured to launch from a surface vessel and couple to a wet mate connector provided on the submarine to form a hardwire communications link between the submarine and surface vessel.

7. The apparatus of claim 6, the high speed communications cable having a first portion to extend proximate the submarine and a second portion to extend proximate the surface vessel when the hardwire communications link is established, the first portion having a higher strength than the second portion.

8. The apparatus of claim 1, the mobile device configured to launch from the submarine, the mobile device interoperable with the coupling point to form a wet mate connection so as to establish a hardwire communications link between the submarine and coupling point.

9. The apparatus of claim 1, the mobile device operable to disconnect from the coupling point so as to sever the hardwire communications link between the submarine and coupling point.

10. A method for high speed underwater communications, comprising:
connecting a first end of a high speed communications cable to a mobile device;
transporting the mobile device underwater from a launching point to a coupling point; and
forming a wet mate connection between the mobile device and coupling point, wherein the high speed communications cable is extended between an underwater submarine and a hardwired link to a surface communications station so as to form a high speed communications link between the underwater submarine and surface communications station.

11. The method of claim 10, comprising providing telemetry via the high speed communications cable operable to guide the mobile device between the submarine and the coupling point.

12. The method of claim 10, comprising providing an optical communications link in the high speed communications cable.

13. The method of claim 10, wherein the mobile device comprises an autonomous underwater vehicle that is self propelled.

14. The method of claim 10, comprising extending the high speed communications cable between a surface vessel and the submarine by transporting an autonomous underwater vehicle connected to a first end of the high speed communications cable from the surface vessel to an underwater connection point on the submarine.

15. The method of claim 10, comprising providing the high speed communications cable with a first portion to extend proximate the submarine and a second portion to extend proximate the surface vessel when the hardwire communications link is established, the first portion having a higher strength than the second portion.

16. The method of claim 10, comprising disconnecting the high speed communications cable from the coupling point so as to sever the hardwire communications link between the submarine and coupling point.

17. The method of claim 10, comprising extending the high speed communications cable between a surface vessel and the submarine by transporting an autonomous underwater vehicle connected to a first end of the high speed communications cable from the submarine to a connection point coupled through a hardwired connection to a surface station.
